(19) United States
(12) Patent Application Publication
(10) Pub. No.: US 2009/0166107 A1
(43) Pub. Date: Jul. 2, 2009

(54) POWER TRANSMISSION METHOD

(75) Inventors: Sébastien Besnard, Sceaux (FR); Nicolas Robart, Issy-les-Moulineaux (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy Villacoublay (FR)

(21) Appl. No.: 12/296,102

(22) PCT Filed: Mar. 28, 2007
(86) PCT No.: PCT/FR2007/051034

§ 371 Date: Oct. 3, 2008

(30) Foreign Application Priority Data
Apr. 5, 2006 (FR) 0603001

(51) Int. Cl. B60K 6/22

(52) U.S. Cl. 180/65.6; 903/945

(57) ABSTRACT

The invention concerns a power transmission method using a transmission device receiving mechanical power from several sources, comprising at least first and second electrical machines, and delivering the power to an output shaft. The method consists in decoupling the first electrical machine from a first input point of the device, then in coupling the first electrical machine to a second input point of the device. The method is characterized in that it consists in, when the first electrical machine is being decoupled, compensating the power (P7) transmitted by the first electrical machine prior to its being decoupled by modifying the power (P6) transmitted by the second electrical machine (6) of the sources such that the power (P4) delivered by the device remains linear.

The invention relates to a power transmission method employing a multi-mode hybrid power transmission device. The invention has a particularly advantageous application in the field of motor vehicles. The transmission device receives mechanical power from several sources, such as a heat engine and multiple electric motors, for example, and transmits this power to the drive wheels of the vehicle.

Transmission devices are known for hybrid vehicles that have a heat engine, two electrical machines and one, two or more planetary gear trains connected to one another within a mechanical assembly. An example of such a device is described in French patent application FR-A-2832357. With such transmission devices, the power from the heat engine can be transmitted directly to the wheels or split by sending it through an electrical system.

The electrical system connects the electrical machines, which are capable of functioning as motors or as generators, depending on levels of electrical and/or mechanical energies received at their terminals and on their shafts, respectively. The split power is retransmitted to the wheels of the vehicle or stored, if applicable, in a storage system. This split power makes it possible to accurately adjust the torque applied to the wheels of the vehicle to match the request of a driver, and at the same time accurately adjust the torque and speed of the heat engine as well, so as to optimize its performance.

Additionally, the electrical system includes, in particular, a first inverter, a second inverter and an electrical bus. In practice, this electrical bus is a direct current bus.

When one of the electrical machines is operating as a generator, the alternating current signals detectable between its phases are transformed by the inverter associated with this machine into a direct current voltage signal detectable on the bus. When one of the electrical machines is operating as a motor, the DC voltage signal detectable on the bus is transformed by the inverter associated with this machine into dephased AC voltage signals. These voltage signals are applied to the phases of the machine that is operating as a motor. In a case where no storage system is connected to the bus, the energy produced by one of the machines is automatically consumed by the other machine. As a variant, a storage system such as a battery or a supercondenser is connected to the bus. Both machines can then operate simultaneously as generators or as motors.

A device that is operable in two different operating modes is described in document FR-A-2832357. In a first mode, the shaft of one of the electrical machines is connected to the wheel shaft, whereas in a second mode, this shaft is connected to an element of one of the planetary gear trains. The mode is selected according to the rotation speed of the wheel shaft and of the element of the gear train. That is, the electrical machine shaft is connected preferentially to whichever element of the two is rotating at the lower speed (adjusted for the intermediate gear ratios). Since power split to the electrical system is equal to a rotation speed of a machine multiplied by a torque, changing from one mode to another makes it possible to reduce the power split to the electrical system. By reducing the power within the electrical system, it is possible to reduce the size of the electrical machines.

Changing from one operating mode to another is accomplished by uncoupling an electrical machine from an initial shaft, then recoupling this same machine to a target shaft. For example, an electrical machine is uncoupled from the wheel shaft to be recoupled to an element of the planetary gear trains.

The general situation is one in which the initial shaft and the target shaft have different rotational speeds. Consequently, it is not feasible to connect the electrical machine to the initial and target shafts at the same time. Therefore, an intermediate phase is necessary, in which the electrical machine is no longer connected to the transmission (connected neither to the initial shaft, nor to the target shaft). During this intermediate phase, the electrical machine is not providing any power to the vehicle wheels. This results in a change in the power output of the transmission device, and thus, in the torque transmitted to the vehicle wheels.

The invention aims to remedy this problem by proposing a new power transmission method in which the power output of the device remains linear while the device is changing operating modes. The power remaining linear is intended to mean that the value of the power has no abrupt changes. As a first approximation, the power output can be considered to remain substantially constant while the device is changing operating modes.

To this end, an object of the invention is a power transmission method employing a transmission device that receives mechanical power from multiple sources, having at least a first and a second electrical machine, and transmitting power to an output shaft, the method consisting in uncoupling the first electrical machine from a first input point of the device, then in coupling the first electrical machine to a second input point of the device, the method being characterized in that, while the first electrical machine is uncoupled, it consists in compensating for the power transmitted by the first electrical machine prior to being uncoupled by modifying the power transmitted by the second electrical machine of the sources, so that the power transmitted by the device remains linear.

In an embodiment where three sources of power are employed, including a heat engine and two electrical machines, the device according to the invention makes it possible to change the coupling of at least one of the electrical machines. During the time in which one of the electrical machines is uncoupled, it is possible to modify the power supplied by the heat engine in order to keep the power transmitted by the device linear. But in a preferred variant in which the sources include at least two electrical machines, the method consists in uncoupling and then recoupling a first one of the electrical machines, and in modifying the power supplied by the second of the electrical machines. That is, it is generally easier to modify the power supplied by an electrical machine than that supplied by the heat engine.

The method according to the invention can be described in that it consists in the following sequence of phases:
canceling the torque transmitted to the device by the first electrical machine,
uncoupling the first electrical machine,
synchronizing the first electrical machine with the second input point of the device,
coupling the first electrical machine to the second input point,

and in that when the torque is canceled, the power of the second electrical machine connected to the device is modified.

The method can be complemented, after coupling the first electrical machine to the second input point, by modifying the level of power supplied by the second electrical machine, whose power was modified according to a level of power supplied by the first electrical machine to the second input point, in such a way that the power transmitted by the device remains linear.

The invention will be more easily understood and other advantages will appear in the detailed description of an embodiment given as an example, illustrated by the attached drawing in which:

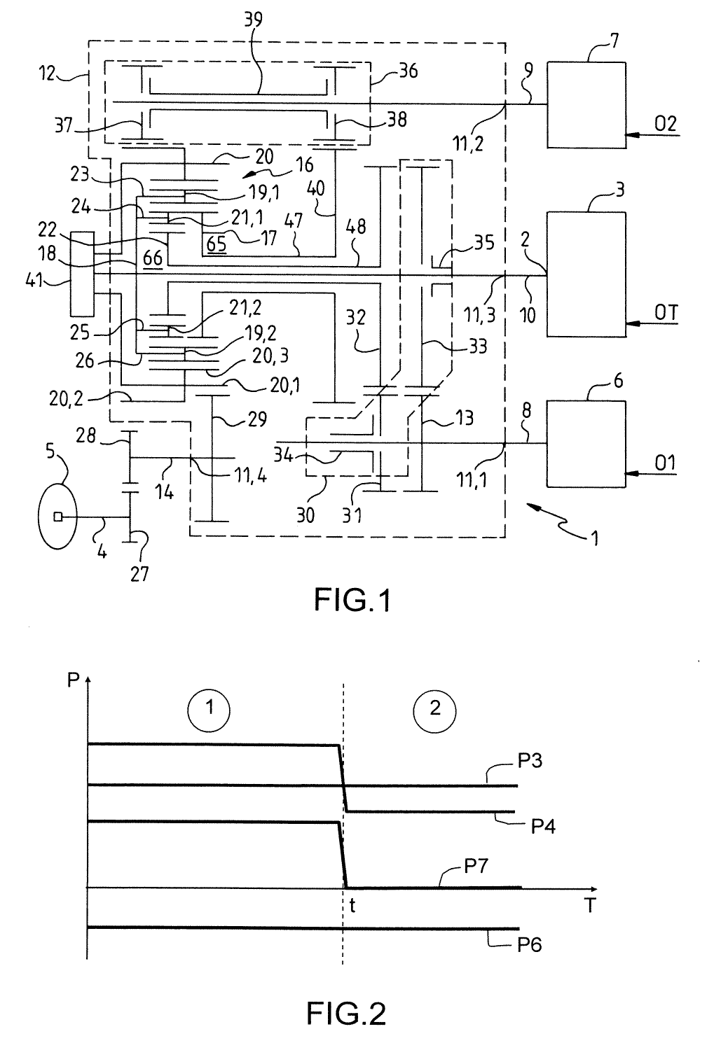

FIG. 1 schematically represents a transmission device for which the invention can be employed;

FIGS. 2, 3 and 5 show a change over time in the mechanical power available at the various input and output shafts of the device of FIG. 1;

FIG. 4 shows a flow chart of an operating mode change in the device 1;

and FIG. 6 shows the change over time in the rotational speed of a power source with respect to a target shaft.

For the sake of clarity, the same element is labeled with the same reference in the various figures.

FIG. 1 shows a schematic representation of a transmission device 1 between an output 2 of a heat engine 3 and a shaft 4 of wheels 5.

The device 1 has a first electrical machine 6 and a second electrical machine 7. The machines 6 and 7 have a shaft 8 and a shaft 9, respectively. The shafts 8 and 9 are connected to drive inputs 11.1 and 11.2, respectively, of a mechanical assembly 12, shown enclosed within a dashed line. The device 1 also has an input shaft 10 connected to the output 2 of the heat engine 3 and to a drive input 11.3 of the mechanical assembly 12. The device 1 also has an output shaft 14 connected simultaneously to the shaft 4 of wheels 5 and to a drive output 11.4 of the mechanical assembly 12. For greater simplicity, the electrical system connecting the electrical machines 6 and 7 to one another is not shown.

More precisely, the mechanical assembly 12 has a so-called Ravigneaux-type gear train 16. The gear train 16 has four mechanical connecting elements: one for the input shaft 10, another for the output shaft 14, and the two others for the shafts 8 and 9 of the machines 6 and 7. Like a conventional planetary gear train, the gear train 16 has a first sun gear 17, a planet carrier 18 carrying a first set of planets 19.1 and 19.2, and a ring gear 20 that intermesh. In addition, the gear train 16 has a second set of planets 21.1 and 21.2, and a second sun gear 22. The second set of planet gears 21.1 and 21.2 is carried by the planet carrier 18, and meshes simultaneously with the first set of planet gears 19.1 and 19.2 and with the sun gear 22.

The Ravigneaux gear train 16 can thus be compared to two planetary gear trains 65 and 66. The first gear train 65 includes the first sun gear 17, the first set of planet gears 19.1 and 19.2, and the ring gear 20. The second gear train 66 includes the second sun gear 22 and the second planet gears 21.1 and 21.2, but it lacks a ring gear. These two gear trains 65 and 66 share the common planet carrier 18. The shared planet carrier 18 drives pins 23-26 in simultaneous contact with the planet carrier 18 and the planet gears 19.1, 19.2, 21.1 and 21.2. The planet gears 19.1, 19.2, 21.1 and 21.2 are rotatable on the pins 23, 24, 25 and 26, respectively. As a variant, the planet gears 19.1 and 21.1 and the planet gears 19.2 and 21.2 can be integral and coaxial with one another, as will be seen below.

In this embodiment, the input shaft 10 is connected simultaneously to the output 2 of the heat engine 3 and to the shared planet carrier 18. The shaft 4 of wheels 5 is connected to the ring gear 20 via a gear assembly made up of the gear wheels 27 and 28, the output shaft 14, and a gear wheel 29. More precisely, the gear wheel 27 attached to the shaft 4 meshes with the gear wheel 28 attached to one end of the output shaft 14. And the gear wheel 29 attached to another end of the shaft 14 meshes with the ring gear 20.

This ring gear 20 bears two sets of outer teeth 20.1 and 20.2 and a set of inner teeth 20.3 for this purpose. The gear wheel 29 meshes with the outer teeth 20.1. The first planet gears 19.1 and 19.2 mesh with the inner teeth 20.3. And a pinion 37 meshes with the outer teeth 20.2, as will be seen below.

The shaft 8 of the first machine 6 is connectable either to the second sun gear 22 or to the input shaft 10. For this purpose, the transmission device 1 has a first switching device 30 shown enclosed within a dashed line. The first device 30 has the pinions 31 and 33 and two distinct dog clutches 34, 35. The pinion 31 and the first dog clutch 34 are mounted on the shaft 8, whereas the pinion 33 and the second dog clutch 35 are mounted on the shaft 10.

Thus, when the shaft 8 is connected to the second sun gear 22, the first dog clutch 34 makes a connection between the pinion 31 and the shaft 8, while the pinion 33 spins freely on the shaft 10. The shaft 8 is then connected to the second sun gear 22 via a gear assembly made up of the pinion 31 and the gear wheel 32, and a hollow shaft 48 connecting the gear wheel 32 to the sun gear 22. When the shaft 8 is connected to the input shaft 10, the second dog clutch 35 makes a connection between the pinion 33 and the shaft 10, while the pinion 31 spins freely on the shaft 8. The shaft 8 is thus connected to the shaft 10 via a gear assembly made up of the gear wheel 13 and the pinion 33.

The shaft 9 of the second machine 7 is connectable either to the shaft 4 of wheels 5 or to the first sun gear 17. For this purpose, the device 1 has a second switching device 36. The second device 36 has pinions 37, 38, and a third, one-piece dog clutch 39.

When the shaft 9 is connected to the shaft 4 of wheels 5, the third dog clutch 39 makes a connection between the pinion 37 and the shaft 9, while the pinion 38 spins freely on the shaft 9. The shaft 9 is then connected to the shaft 4, in particular via the pinion 37, the ring gear 20 and the output shaft 14. When the shaft 9 is connected to the first sun gear 17, the dog clutch 39 makes a connection between the pinion 38 and the shaft 9, while the pinion 37 spins freely on the shaft 9. The shaft 9 is then connected to the first sun gear 17 via a gear assembly made up of the pinion 38 and the gear wheel 40, and a hollow shaft 47 connecting the gear wheel 40 to the sun gear 17.

As a variant, the first device 30 has a one-piece dog clutch and is mounted solely on the shaft 8. According to another variant, the second device 36 has two separate dog clutches mounted on the shaft 9.

The dog clutches 34, 35 and 39 are rotationally driven by the shaft on which they are mounted, and are capable of moving translationally along this shaft. Generally, the dog clutches are moved translationally via forks driven by a direct current motor, which is not shown.

In a particular embodiment, the shared planet carrier 18 and the ring gear 20 are connected to an oil pump 41 via a free-wheel mechanism (not shown).

As a variant, the shafts 8 and 9, the input shaft 10 and the output 5 shaft 14 are connected to different elements of the gear train 16.

FIG. 2 shows a change over time in the mechanical power available at the various input and output shafts of the device. Consider a state of the transmission device 1 in which the dog clutch 34 makes a connection between the shaft 8 of the electrical machine 6 and the pinion 31. The dog clutch 39 makes a connection between the shaft 9 of the electrical machine 7 and the pinion 37. In a first phased the first electrical machine 6 is rotationally connected to the second sun gear 22, and the second electrical machine 7 is rotationally connected to the shaft 4 via the ring gear 20 and the output shaft 14. The first electrical machine 6 supplies the device 1 with a mechanical power P6, and the second electrical machine 7 supplies the device 1 with a mechanical power P7. The electrical machine 6 is operating in generator mode in the example shown, and the power it supplies to the device 1 is negative by convention. The electrical machine 7 is operating in motor mode, and the power it supplies to the device 1 is therefore positive. The heat engine 3, for its part, is providing a power P3 to the device 1. On the shaft 4, the device 1 provides a power P4 to the wheels 5. The power P4 is the sum of the powers received by the device, namely, P3, P6 and P7.

At an instant t, a decision is made to uncouple the electrical machine 7 from the shaft 4. In order to do this, the power P7 that the electrical machine 7 supplies to the device 1 is canceled before uncoupling. Uncoupling can be done in a phase referenced \textcircled{2} in FIG. 2. In this new phase, the powers P3 and P6 supplied to the device 1 by the electrical machine 6 and the heat engine 3 are identical to the powers supplied in phase \textcircled{1}. Consequently, the power P4 supplied to the wheels 5 has dropped.

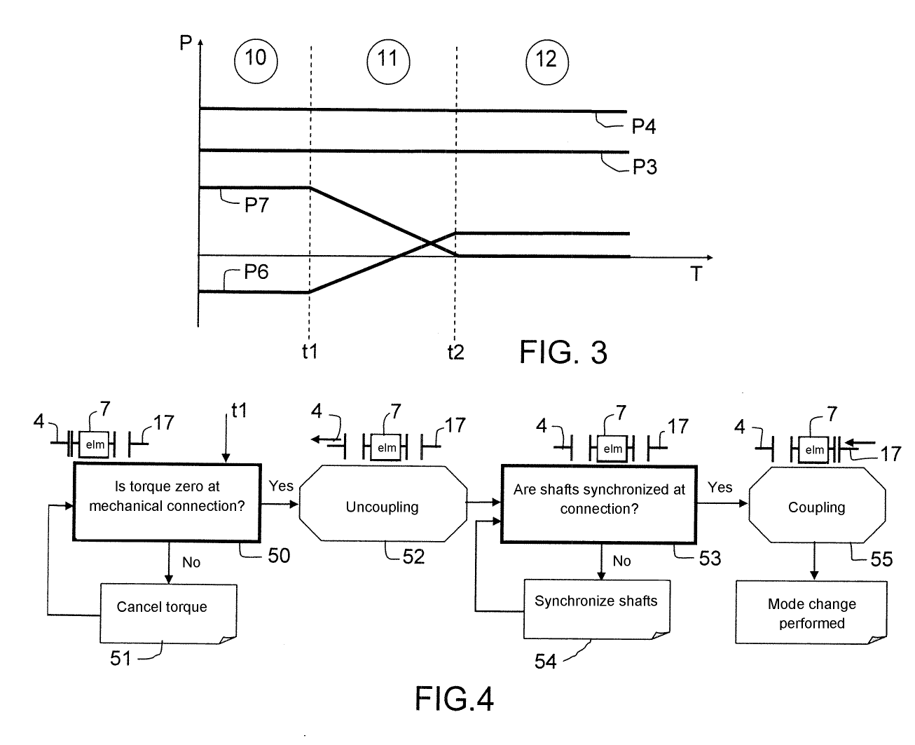

In FIG. 3, the method according to the invention is employed in order to avoid the drop in power observed in FIG. 2. Phase \textcircled{10} is identical to the previously described phase \textcircled{1}. At an instant t1, when there is a decision to uncouple the electrical machine 7 from the shaft 4, a phase 11 begins in which the power P7 supplied by the electrical machine 7 is reduced to zero. During this same phase \textcircled{11}, the power P6 that the electrical machine 6 supplies to the device 1 is increased in such a way that the power P4 transmitted from the device to the wheels 5 remains constant. Following phase \textcircled{11}, a phase \textcircled{12} begins at instant t2. In phase \textcircled{12}, the power supplied by the electrical machine 7 remains at zero, which allows it to be uncoupled, and the power P6 supplied by the electrical machine 6 is constant, remaining at the level where it was at the end of phase \textcircled{11}. In the example illustrated in FIG. 3, the power P4 transmitted from the device 1 to the wheels 5 remains constant. In practice, it is often helpful to change the operating mode of the device 1 when the level of power to be transmitted to the wheels 5 changes. But for driving comfort in a vehicle equipped with the device 1, and in order to avoid too high a demand on the various mechanical members through which the power passes on its way to the wheels 5, it is important for the power supplied to the wheels 5 to change levels smoothly. For example, the method of the invention can be applied in a case where the curve representing the power P4 in FIG. 3 increases continuously over time.

In order to implement the invention, one could also modify the power P3 supplied to the device 1 by the heat engine 3. But it is generally easier to modify the power of an electric motor than the power of a heat engine. The power supplied by an electrical machine is modified, for example, by controlling an inverter placed between phases of the electrical machine and a direct current bus. There are reversible inverters that enable an electrical machine to change from a generator mode to a motor mode and back.

FIG. 4 shows a flow chart for changing the operating mode of the device 1. During this change, the electrical machine 7 goes from being coupled to the shaft 4 to being coupled to the first sun gear 17. Of course, this flow chart can be implemented to change the coupling of the electrical machine 6. At an instant t1, when there is a decision to uncouple the electrical machine 7 from the shaft 4, the torque produced by the electrical machine 7 at its shaft 9 must be canceled before proceeding with uncoupling. The torque cancellation command is represented by step 50, and the torque cancellation verification is represented by step 51. When torque cancellation has been accomplished, phase \textcircled{12} can be started, and the shaft 4 of the electrical machine 7 can be uncoupled. Uncoupling is represented by step 52. Next, before coupling the electrical machine 7 with the first sun gear 17 by means of the dog clutch 39, as represented in step 55, the rotational speed of the shaft 9 of the electrical machine 7 must be synchronized with the speed of the first sun gear 17. The synchronization and verification thereof are represented by steps 53 and 54, respectively. Following synchronization, the coupling is coupled, and the change of operating mode of the device becomes effective.

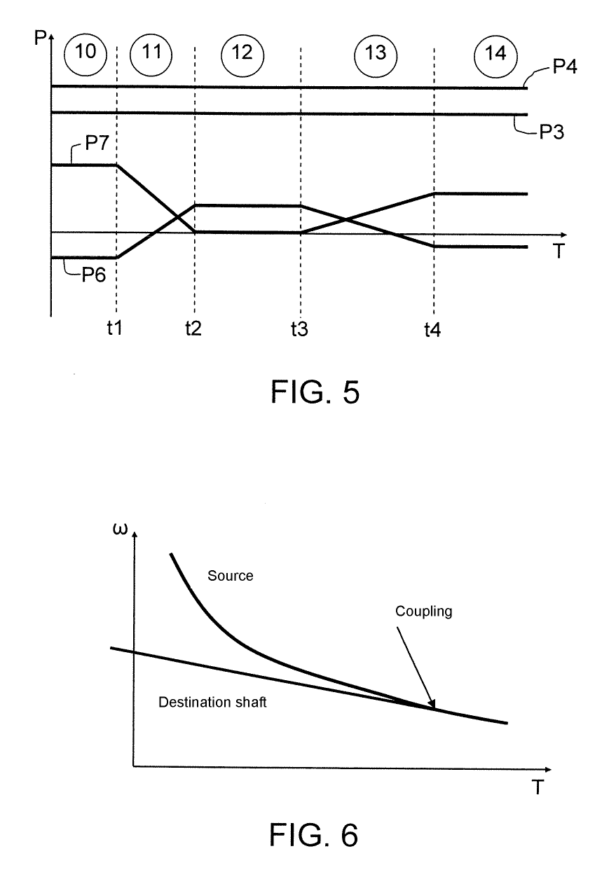

At the moment the electrical machine 7 couples with the first sun gear 17, the power transmitted to the device 1 by the electrical machine 7 is zero. The end of coupling occurs at instant t3. From this instant on, the level of power P6 supplied by the electrical machine 6 can be modified in response to a change in the level of power P7 supplied by the electrical machine 7, so that the power P4 transmitted by the device 1 remains constant, as shown in FIG. 5, or linear. The change in power levels P6 and P7 of the electrical machines 6 and 7 after coupling is illustrated by FIG. 5. This change in the power levels P6 and P7 supplied by the two electrical machines 6 and 7 takes place in a phase \textcircled{13} beginning at instant t3 and ending at an instant t4. Phase \textcircled{13} is followed by a phase \textcircled{14} during which the power levels P3, P6 and P7 supplied to the device 1 by the various sources—electrical machines 6 and 7, heat engine 3—remain constant, or optionally, linear.

FIG. 6 shows the change over time in the rotational speed ω of a power source, e.g., the electrical machine 7, relative to the speed of a target shaft, e.g., the first sun gear 17, in order to enable them to couple without endangering the dog clutch involved, in this case, the dog clutch 39.

1. Power transmission method employing a transmission device that receives mechanical power from multiple sources, having at least a first and a second electrical machine, and transmitting power to an output shaft, the method consisting in uncoupling the first electrical machine from a first input point of the device, then in coupling the first electrical machine to a second input point of the device, the method comprising, while the first electrical machine is uncoupled, compensating for the power transmitted by the first electrical machine prior to being uncoupled by modifying the power transmitted by the second electrical machine of the sources, so that the power transmitted by the device remains linear.

2. Method according to claim 1, comprising uncoupling and then recoupling the first electrical machine and modifying the power supplied by the second electrical machine.

3. Method according to claim 1, comprising the following sequential phases:
canceling the torque transmitted to the device by the first electrical machine;
uncoupling the first electrical machine;
synchronizing the first electrical machine with the second input point of the device;
coupling the first electrical machine to the second input point;
wherein when the torque is canceled, the power of the second electrical machine connected to the device is modified.

4. Method according to claim 3, comprising, after coupling the first electrical machine to the second input point, modifying the level of power supplied by the second electrical machine, whose power was adjusted according to a level of power supplied by the first electrical machine to the second input point, in such a way that the power transmitted by the device remains linear.

5. Method according to claim 2, comprising the following sequential phases:
canceling the torque transmitted to the device by the first electrical machine;
uncoupling the first electrical machine;
synchronizing the first electrical machine with the second input point of the device;
coupling the first electrical machine to the second input point;
wherein, when the torque is canceled, the power of the second electrical machine connected to the device is modified.

6. Method according to claim 5, comprising, after coupling the first electrical machine to the second input point, modifying the level of power supplied by the second electrical machine, whose power was adjusted according to a level of power supplied by the first electrical machine to the second input point, in such a way that the power transmitted by the device remains linear.
